(19) United States
(12) Patent Application Publication
(10) Pub. No.: US 2003/0084448 A1
(43) Pub. Date: May 1, 2003

(54) Automatic viewing-history based television control system

(75) Inventor: Aravind Soundararajan, Ossining, NY (US)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/043,378

(22) Filed: Oct. 26, 2001

(51) Int. Cl. H04N 7/16; H04H 9/00; G06F 3/00; H04N 5/445; G06F 13/00

(52) U.S. Cl. 725/46; 725/27; 725/14

(57) ABSTRACT

A system and method for automatically building, updating and using television channel selection lists for enhanced television (TV) control. A TV controller is placed in communication with a TV-programming display such that at least some of the multi-channel programming input is routed to the TV through the TV controller. Initially all channels in the multichannel input stream are accorded equal weight values. A television viewer selects the programming material for display in the normal fashion. A display-time timer located in the TV controller measures the amount of time a viewer spends watching each channel and this information is recorded in a viewer-history log in a database of the TV controller. A processor of the TV controller, under the direction of a control program, periodically reviews the viewer-history log, and uses the viewing time information stored there to assign weighted values to each viewed station. These weighted values are then applied to a channel selection control list. The list, which now contains up-to-date viewer-preference information, is used to control the channel-selection process and to generate on-screen menus for use in enhanced channel control.

### BACKGROUND OF THE INVENTION

Televisions (or TVs) are electronic home-entertaining devices used primarily for the display of audio-visual programs. Although the TV itself generally includes sound speakers (internal or external) and a picture tube or screen, these components are driven by input signals originating outside of the TV itself. There are many sources of these TV signals. Originally, virtually all such signals, that is, TV programming, came over the airwaves from a broadcasting company and were picked up by an antenna connected to the TV. Only a handful of separate broadcasting stations, and sometimes as few as one, were within range of a given TV antenna, and the TV viewer chose between them by manipulation of a tuning element. Occasionally, an antenna would be set up in an advantageous location and shared by a number of community members, a practice especially useful where reception by a home-based antenna was difficult or impossible. Community antenna television (CATV) systems in this way allow access to broadcast TV programming that would otherwise be unavailable.

Even with limited program availability, television audiences grew, and this growth spurred the creation of additional broadcasting facilities. Improvements in technology fed the growth, and eventually there were literally hundreds of separate program channels available for viewers to choose from. CATV became widespread and popular even with those who had no difficulty receiving broadcast programs through their antenna, in large part because of the wide variety of channels available. Satellite broadcast television programming has also increased in popularity for much the same reason. As a result of this growth, many viewers may now have well over a hundred channels or viewing options to choose from.

This phenomenon is both a benefit and a burden. While the increase in program options provides a greater choice, including many programs made for a limited audience, it also results in difficulty; or at least inconvenience, locating a program for viewing. In part, this is due to the way in which many people watch TV. Although it is not uncommon for some viewers to intentionally tune in to a particular program at a particular time, it is also common for viewers to “surf”, that is, to move quickly through the available channels, staying tuned to each one only long enough to determine if something of interest to them is being aired. In other words, a particular viewer may want to watch TV during a period of leisure, but have no definite program selection in mind. This search process is facilitated by TV remote-control devices that allow the viewer to simply switch to the next channel in numerical succession. In such a case, this viewer will face the prospect of examining many channels in order to make a decision, with many of the channels airing material that is of no interest to them. This process may, therefore, take a considerable amount of time, even if only a short interval is spent on a particular channel before moving on to the next.

Various means have been employed in an effort to avoid the inconvenience faced by a viewer who is forced to spend an inordinate amount of time surfing channels, attempting to make a program selection. The viewer, of course, may simply elect to only review channels that are known to contain matters of interest. This can be done by entering the channel numbers directly, to the extent they are committed to memory, or by moving from channel to channel using the conventional channel selector but not pausing to view intermediate stations. Many TV remote controls also allow the viewer to select certain channels as “favorites,” and only those channels are tuned in when using the sequential channel function. (Non-favorite channels then being accessible only through direct input of the station number.) These selections may, of course, be changed by manual viewer input, but otherwise remain the same unless lost through a power outage.

One solution offered by some TV programming providers is the electronic program guide (EPG). The guide is a channel (or channels) of information that produces for display a program listing that the viewer can refer to in making a program selection. The guide will generally list both current programming and that scheduled to air in the near future. More sophisticated EPGs may allow the viewer to select a TV program appearing on the program listing and find out more information about it, or simply switch to it directly. In addition to displayable information, the EPG may also include supplemental information that is used in some way by the receiving system though not displayed by the viewer. The EPG and any supplemental materials accessed through it are simply additional content sent on a transmission channel dedicated to this purpose. Information such as EPG displayable and supplemental content is sometimes generally referred to as “meta-data” (that is, data about data).

Each of the solutions described above, however, while providing a useful convenience, still require that the viewer review the programs or programming guide and take some action to effect the program selection process. Needed is a method that can automatically identify viewer favorites and preferences, and use this information to enhance the viewing experience by making the channel selection process more attuned to what the viewer likes to watch.

### SUMMARY OF THE INVENTION

To address the above-discussed deficiencies of the prior art, it is a primary object of the present invention to provide a method for automatically determining and applying viewer television-channel preferences. A database is provided to store information collected by a monitoring program so that a viewing history may be compiled. The viewing history contains, for example, a list of channels were watched by the viewer and for how long, what programs or types of programs were being watched (based upon meta-data associated with a viewed program), and whether frequent channel changes were made during the program. An evaluation program then analyzes this information and assigns a weight value to the particular channels viewed, the value being based on how much time the viewer spent on this channel relative to others. Behavior, such as surfing habits, may also be included, for example by according less weight to a program that was switched away from a number of times.

In one embodiment, viewing history information can be gathered and analyzed for each of any number of identified viewers.

Using the evaluation-program weight values, a favorites list is automatically created and stored. The list contains a preselected number of channels and is sorted by weight value. The list is applied in several ways.

In one embodiment, the list appears on the viewers screen when it is turned on, allowing the using to scroll through to make channel selections. Alternately, the list appears when requested by the user, for example by depressing an appropriate button on the TV, a set-top box, or on a remote control. Where an electronic program guide (EPG) is available, the list may also be displayed whenever the EPG is selected for display. Ideally, the list would appear first (at the ‘top’ of the EPG), beginning with the highest-weight-value channel on top; the normal EPG would follow the lowest-weight-value channel on the list. In another embodiment, EPG channel entries that are on the list may be highlighted in some way.

It In another embodiment, the TV, when turned on, automatically displays first the most heavily weighted channel, with or without the menu also available for making an alternate selection.

In yet another embodiment, multiple lists are created for each viewer, for use at a predetermined time, for example one for weeknight viewing, one for weekends, one for Sunday morning.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, lo have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary television system according to one embodiment of the present invention.

FIG. 2 is a block diagram illustrating the interconnectivity of selected set-top box components configured according to an embodiment of the present invention; and

FIG. 3 is a flow chart illustrating a method of assembling a program selection control list according to an embodiment of the present invention.

FIG. 4 is a flow chart illustrating a method of generating and using a channel-selection menu according to one embodiment of the present invention.

### DETAILED DESCRIPTION OF THE INVENTION

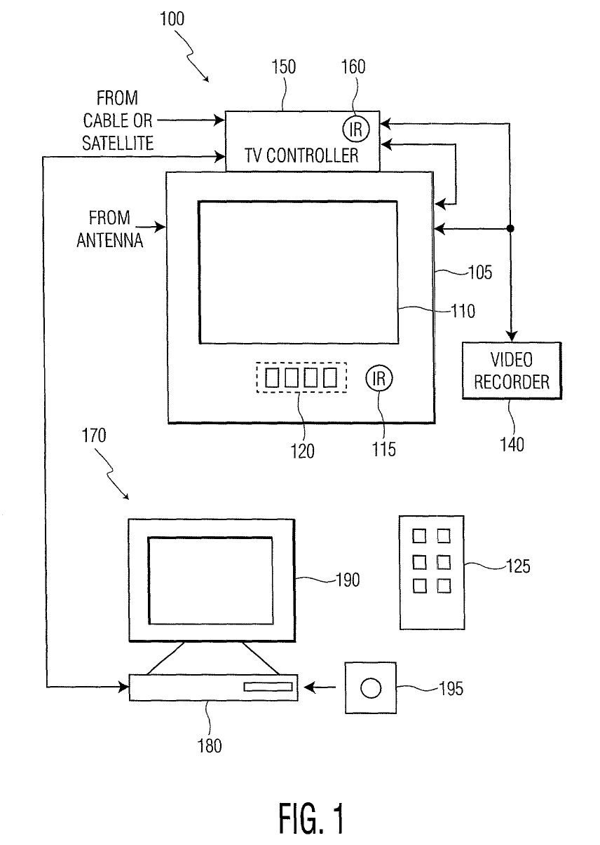

FIGS. 1 through 4, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, a digital television (TV) receiver. However, this embodiment is by way of example only and should not be construed to limit the scope of the present invention to digital television receivers. In fact, those skilled in the art will recognize that the exemplary embodiment of the present invention may easily be modified for use in analog television receivers.

FIG. 1 illustrates an exemplary television system 100 according to one embodiment of the present invention. Exemplary television system 100 comprises televison receiver 105, TV controller 150 with infrared (IR) detector 160, and video recorder 140. As will be explained below in greater detail, the present invention provides a system for creating a personalized television channel control system for the operation of television receiver 105, according to the personal tastes of one or more viewers, and more specifically one attuned to their regular viewing habits.

Television receiver 105 comprises display screen 110 for displaying television programs provided by a cable or satellite television program service provider, infrared (IR) sensor 115, and a set of manual controls 120, as indicated by a surrounding dotted line. Manual controls 120 may include, without limitation, a power button, a volume control button, vertical and horizontal control buttons and one or more channel selection buttons. Infrared (IR) sensor 115 receives IR control signals from an optional hand-held remote control 125 that may be operated by the television viewer. Typically, IR control signals from remote control 125 that are detected by IR sensor 115 are processed within television receiver 105 in order to change the channel being viewed on display screen 110, to increase or to decrease the volume, to turn television receiver 105 on and off, and the like. Optionally, the IR control signals detected by IR sensor 115 may be relayed to TV controller 150 in order to control its operation.

TV controller 150 performs conventional tuning and demodulation of incoming signals from a cable or satellite television program service provider to produce, for example, a stream of Moving Picture Experts Group (MPEG) encoded digital data from which video signals may be derived. Alternatively, television receiver 105 may directly receive an incoming television-program signal from an external antenna (not shown) or other alternate source. In this alternative embodiment of the invention, television receiver 105 itself performs conventional tuning and demodulation of incoming RF signals received from the alternate source to produce, for example, a stream of MPEG encoded digital data from which video signals may be derived.

Other programming sources include video-game input signals and video from a video camera (camcorder). In most instances, use of one of these devices indicates a viewer preference to override the automatic channel selection options of the present invention, although this is not necessarily the case. In yet another embodiment, input from devices such as video-game players are routed through the TV controller and taken into account in executing the processes of the present invention, explained below. Alternate programming sources may also include video images commonly viewed on personal computers, or personal digital assistants or other web-enabled devices. Again, this alternate programming may be routed through TV controller 150 or transmitted directly to television receiver 150. Note, however, that the distinction made here relating to which component is physically connected to receive certain inputs is illustrative only, and not intended to imply a functional limitation. In other words, all input may first enter receiver 105, with some or all of it then directed from there to TV controller 150 for processing in accordance with the present invention. Likewise, components such as TV controller 150 and video recorder 180 are shown separately, but could easily be physically co-located in a common enclosure with display 110.

TV controller 150 also comprises infrared (IR) sensor 160. IR sensor 160 receives infrared (IR) control signals from hand-held remote control 125 operated by the television viewer. Preferably, remote control 125 that operates TV controller 150 is the same remote control 125 that controls television receiver 105. Typically, IR control signals that are detected by IR sensor 160 are processed within TV controller 150 in order to change the channel being transmitted to television receiver 105 for viewing on display screen 110, to turn TV controller 150 (or television receiver 105) on and off, and to adjust other television controls. As mentioned above, in an advantageous embodiment of the present invention, TV controller 150 may be integrated into television receiver 105. The integration of TV controller 150 and television receiver 105 is desirable where it can reduce the amount of equipment, wiring, and set-up effort required to be performed by the television viewer.

In another advantageous embodiment of the present invention, the system of the present invention may be an embedded system integrated into television receiver 105. In an alternate advantageous embodiment of the present invention, the system and method of the present invention may be partially or completely implemented in a separate personal computer (PC) 170. PC 170 comprises central processing unit (CPU) 180, video monitor 190, and removable storage medium 195. PC 170 also comprises conventional elements (not shown) such as a keyboard, a mouse, an internal hard disk drive, and a random access memory (RAM). The control program used in execution of the present invention and the necessary data files may also be stored on removable storage medium 195, which may be, for example, a 3.5 inch floppy diskette, a compact disk read only memory (CD ROM), a digital video disk (DVD), or a similar storage medium. In the event that PC 170 is used, the TV controller 150 may be a standard set top box that simply performs the tuning and demodulation functions with respect to incoming video signals so that they may be displayed. In the absence of PC 170, or some other suitable device, TV controller 150 contains the components necessary for enhanced TV control using program selection control lists, as more fully explained below.

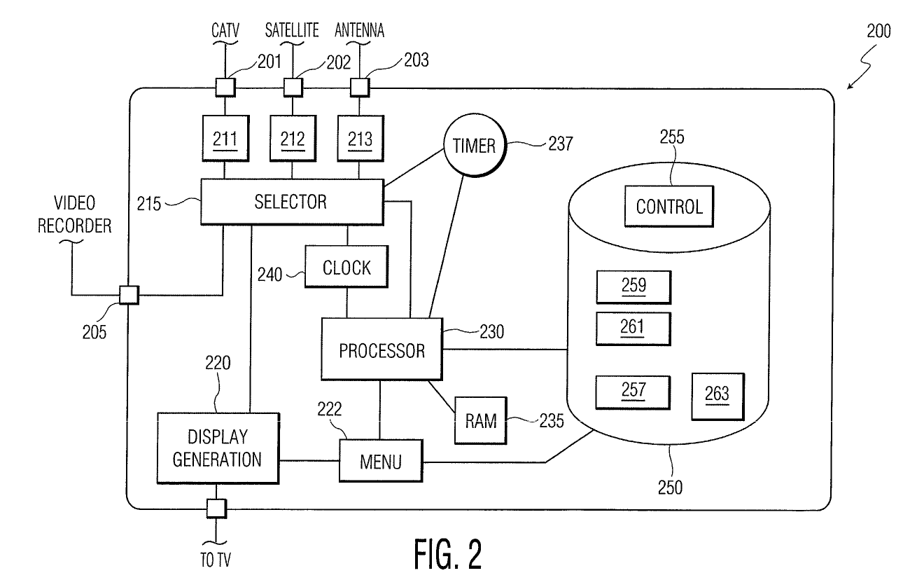

FIG. 2 is a block diagram illustrating the functional interconnectivity of selected components of TV controller 200 configured according to an embodiment of the present invention. TV controller 200 includes CATV input port 201, satellite broadcast input port 202, and antenna input port 203, each connected with input-processing modules 211, 212, and 213, respectively. As should be apparent, this embodiment differs slightly from the one depicted in FIG. 1; the antenna input here is shown being directly input to TV controller 200. It is generally preferred for maximum advantage, although not necessarily, that as many inputs as possible be routed directly to TV controller 200 and then distributed to other components. For example, the antenna input may be routed to TV receiver 105 and therein divided so that the signal is sent to the TV controller (processed or unprocessed) and also available in receiver 105 for independent use even when the controller is unavailable. Program input signals are received from their respective sources and passed through the respective input-processing modules. There may also be a single input processing module serving all or any number of input sources, if permitted by the types of signals being received. When selected by selector 215, the processed input signals are passed to display generation unit 220. Note that as shown in FIG. 2, the selector 215 both selects which source to draw programming from and selects the individual channel from those available at the source. This dual function is often performed by separate components. The system and method of the present invention, however, is most advantageously applied, however, where input may be monitored and selected at the individual channel level. Recorded programming unit from a local source such as the video recorder 140 shown in FIG. 1, enter TV controller 200 through input port 205 and, when selected by selector 215, are passed on to display generation unit 220. Display generation unit 220 is connected to display unit 110 of receiver 105.

Note that, as used herein, “channel” refers to the source of audio or video input that is chosen, manually or automatically, for viewing, recording, or some other operation. The “channel” may be one of many delivered from a broadcast CATV or satellite provider, or from a local source such as a video camera, DVD player, or VCR. Channel selection is the act of making this choice, but may be done by a viewer or automatically by the system. If done by the system, the viewer may or may not be asked to confirm the selection's desirability.

Note also that some of the components illustrated in FIG. 2 and described above are generally analogous to functional modules found in current set top boxes and decoders associated with receiving program input from any one of the numerous available sources and preparing it for display on display unit 110. There is no requirement, of course, that all of these components be located in the same physical unit. In one embodiment, the input processing modules and display generation unit are located outside of, but functionally connected with, TV controller 200.

Returning to the embodiment of FIG. 2, processor 230 directs and controls the operations of TV controller 200 in accordance with control program 255 stored on database 250. Processor 230 uses random-access memory (RAM) 235 in performing these operations and is preferable also in communication with a non-volatile read-only memory (ROM) (not shown), which is programmed to direct the boot strapping process after a power-down, power-up sequence. Note that if the television system 100 includes a PC 170 (as shown in FIG. 1), the processor 230, RAM 235, and database 250 may be contained there in lieu of, or in redundant addition to, the analogous components of TV controller 200.

In the embodiment of FIG. 2, also included in TV controller 200 is a timer 237 coupled to selector 215 and processor 230 and a menu generator 222 in communication with both processor 230 and display generation unit 220. Timer 237 measures how time is spent viewing each channel so that a viewing-history log may be annotated. For convenience, viewing time is herein considered the period between selection of one channel (the “viewed” one) and the subsequent selection of another. It only includes, however, the time during which the viewing or recording device for which the selection applies is actually turned on. In the basic embodiment, there is no consideration given to whether a live viewer is actually present during a television display “viewing” period. In many cases, of course, a viewer will not be present when a channel is selected for recording. When recording is performed, selector 215 selects the appropriate input and transmits it to a video recorder via input/output port 205. Previously recorded materials may, of course, be selected as an input and transmitted for display.

A signal for enabling timer 237 (not shown) may be used to ensure it only runs when a program is being displayed or recorded. In a preferred embodiment, processor 230 determines whether a given program is being displayed, recorded, or both, so that this information may be stored on the viewing history.

Clock 240, which may be set by the viewer and run independently or set from the programming content (provided to it, for example, by the selector 215) or it may be set from some other source. As distinguished from timer 237 (or from a system clock for synchronizing data), clock 240 provides the processor 230 with the actual time, day, date and year to use, for example, in selecting programming that airs at a known time. In an alternate embodiment, clock 240 is not a separate component; day and time data in this case being derived directly from the EPG or other incoming program signal.

Menu generation unit 222 is for generating, at the direction of processor 230, channel selection menus based on the weighted program control list 257 stored on database 250. Menu generation unit 222, which may also simply be an incorporated function of display generation unit 220, creates menus that viewers may use to select programming channels. Program selection control list 257 is compiled according to a predetermined algorithm and based on information concerning the amount of time a user spends watching each particular channel, as stored in the viewing history 259.

Preference profile 261 contains information concerning the individual preferences of the viewer. Naturally, if viewers identify themselves individually, any number of viewer profiles can be created. Much of the information in preference profile 261 is manually entered by the viewer in order to, in a preferred embodiment, allow the viewer to influence the operation of the system of the present invention, which otherwise operates mostly automatically. Preferably, the viewer simply changes default preference indicators so that in fact no manual input is actually required. The preference profile information may allow the viewer to directly address certain settings, or may simply use viewer responses to predetermine queries to generate settings, the use of which is discussed below.

In operation, TV controller 200 receives programming input from a variety of sources and, as directed by the user or by automatic system operation, causes the audio-visual presentation associated with one or more programming channels to be displayed on display 110. It may also be used to direct the same or some selected other programming information to be sent to a recording device to be saved for later viewing or processing. As programming channels are selected, the time spent viewing (or recording) them is stored in database 250, and this information is used to create channel selection control lists that will be used to assist the viewer in controlling the channel selection process.

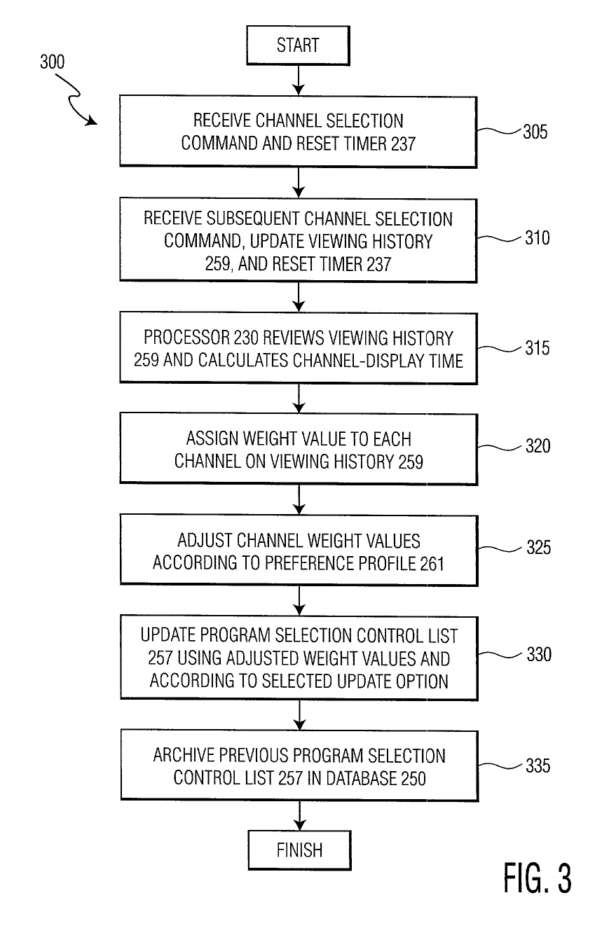

FIG. 3 is a flow chart illustrating a method 300 of assembling a program selection control list 257 according to an embodiment of the present invention. Initially (process step START), a properly configured TV controller has been connected with a display unit such as a television and one or more sources of programming as shown, for example, in FIG. 2. As mentioned previously, this configuration is exemplary and not intended to be limiting. The steps of the process described below may be implemented by appropriate circuitry in the set-top box, or alternately, in the television itself or some other device. The various functions associated with method 300 may also be distributed among various components. When the TV controller 200 receives a channel-selection command(via, for example, IR detector 160 shown in FIG. 1), the timer 237 is reset and begins to time the duration for which the channel is being viewed (process step 305). Some channels may, of course, be viewed for only a short time. In one embodiment, a channel presence with a duration less than a certain predetermined duration, for example, one second, are ignored. In another embodiment, all channels are used in the analysis regardless of duration. In either case, when a subsequent channel selection request has been received, it is stored in the database (process step 310). Preferably, the stored information includes the identity of the channel itself (which could be the channel number known to the viewer, or some other identifier), including the source, and the duration for which the channel was viewed. In one embodiment, also recorded is information concerning the type of programming that was airing on the channel at the time it was being viewed.

At predetermined intervals, the channel-preference control program 255 instructs processor 230 to review the viewing history 259 information in database 250 and calculate the amount of time spent on each channel (process step 315). The channels are ranked according to the amount of time spent watching them during the interval since the last previous calculation on a weight value is assigned to each channel (process step 320). Note that in this embodiment, the weight value is based only on viewing habits recorded since the previous interval. The process then proceeds to step 325 where the weight values are adjusted according to viewer preference as stored on preference profile 261 in database 250. As mentioned above, preference profile 261 contains viewer preference information, which is used in a preferred embodiment to adjust the operation of the system of the present invention to more closely suit the viewer's individual tastes and habits. This information is generally input by the viewer, but may also, or alternately, include automatically generated information as well.

In a preferred embodiment, one way the preference profile 261 information is applied is in the adjustment of weight values. For example, although the weights are originally assigned based on viewing time over a given period, the weight value may be adjusted before it is actually used, based on a manually entered preference. For another example, the viewer may enter in the profile a choice as to how the weighted value will be used. The program selection control list is then updated according to the viewer-selected (or default) update option (process step 330). This option, for example, dictates whether to ignore previous control lists and update by creating a completely new list, or to perform the update by taking previous lists into account, either on an equivalent basis or by giving greater weight to either the old or new weight values. In this way, the user selects, in effect, a slowly changing control list where newly calculated weights have a relatively small impact, a more quickly changing list, or one that completely replaces the previous one. Other update options may, of course, be used. At the same time as the update, the previous list is saved to an archive 263 in database 250 (process step 330). In this way, a previous list may be restored, generally at viewer request, either as it actually existed or as modified.

In an alternate embodiment, the viewer may also suspend the update process, for example, when visiting guests having disparate viewing habits may undesirably affect the list, or simple because the viewer is satisfied with a particular list and wishes to retain it. Optionally, during the suspension period temporary channel-control a list may nevertheless be compiled according to the process described herein, this temporary list to be either saved or discarded when normal operation is resumed. And, as previously mentioned, if multiple viewers identify themselves individually, any number of preference profiles 261, viewing histories 259, and program selection control lists 257 may be generated and stored on database 250.

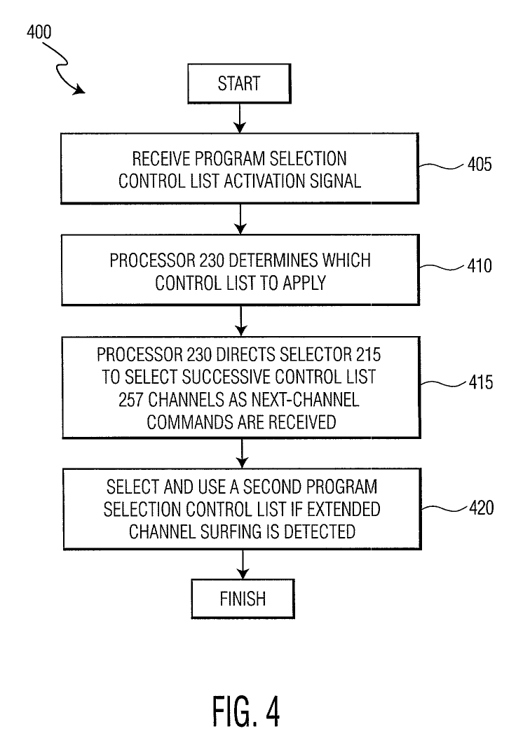

FIG. 4 is a flow chart illustrating a method 400 of generating and using a channel-selection menu according to one embodiment of the present invention. At the beginning of process 400 (process step START), the channel-control lists 257 have been assembled according to the method 300 described above and illustrated in FIG. 3. When a control list activation signal is received (process step 405), processor 230 of TV controller 200 determines the appropriate channel-control list 257 to apply (process step 410). The control-list activation signal may be generated whenever the system is powered-on, or when a menu is invoked by the viewer. This may be an explicit request for a menu, or a signal automatically generated when, for example, channel surfing is detected. In one embodiment, the appropriate control list is determined and applied as soon as the viewer uses the next channel (up or down) button on the remote control. In an alternate embodiment, the buttons function normally until more than, for example, three channels are selected in rapid succession, and only then is the appropriate program selection control list 257 applied. Or the viewer may select a menu display of control list channels, in which event, menu generator 222 causes display generation unit 220 to display a menu for use by the viewer (step not shown). Note, however, that the determination of an appropriate control list does not mean necessarily that the menu is displayed to the viewer. As mentioned previously, the channel control list contains a number of channels assembled according to viewer watching habits and adjusted according to user preferences. There may be multiple lists depending on the current date and time, or depending on which viewer has identified themselves, or both. When one of these lists has been determined to be appropriate (step 410), processor 230 directs selector 215 to cycle through the list as next-channel commands are received (process step 415). A next-channel command is a viewer command to proceed to the next channel, for example by using the channel up/down buttons on remote control 125, but has not entered an explicit command to proceed to a certain channel. In this way, the viewer surfs through only those channels previously determined to be preferred. In the illustrated embodiment, if channel surfing continues beyond a predetermined level, a second channel control list is selected (process step 420). This second list may be, for example, enlarged; that is, the first list with additional channels added to it, or a completely new list containing a different set of channels. In this way, a user who has been to each of the channels contained on the first list twice, for example, is given more choices. Although not shown, a third and a fourth list may also be selected, and so on even until the channel control list being used contains all available selections. In a preferred embodiment, the user may manually switch back and forth between the various control lists. This may also be effected automatically, for example where a viewer's channel surfing pace has slowed, with each channel in succession viewed for a certain predetermined time period.

Even though the list may be available, the electronic program guide (EPG), if present, may be used as well by the viewer. In one embodiment, the list appears whenever the EPG channel is selected, either in lieu of or in addition to the EPG. In the latter case, the list preferably appears at the top of the EPG. Generally, the channel having the highest weight value will appear at the top of this list, and the listed channel will appear at the bottom, just above the regular EPG listing. The list may incorporate EPG metadata to emulate the look and feel of the EPG, or may be designed to appear distinct. Again, the list contains only a select subset of the channels, usually less than, and preferably much less than all of them (to effect ease of use). The number of listed channels, for example, may be predetermined, or the list may include all channels that have been viewed for over a threshold amount of time. The number of channels in the list (as displayed) may be, when displayed together with the EPG, more or less than the number of channels shown in the list as displayed on its own. In another embodiment, the EPG itself is regenerated in such a way that listed channels are noted or highlighted, a feature that may be used together with the separate, initial list display described above.

Finally, as the program selection control list is compiled to according to automatically collected viewing history data and, if necessary, adjusted for explicit viewer preferences, additional features may be incorporated. For example, if the viewing history 259 reveals a certain television program is regularly viewed (or recorded), a “regular viewing” notation may be included in program selection control list 257. This notation may result, in accordance with any relevant option recorded in preference profile 261, in automatically displaying or recording of the program at the appropriate time (unless, of course, the program is already being displayed or recorded). Note also that other useful information may be preserved, for example, in the viewer history 259, such as the audio and video settings selected by the viewer while a particular programming channel is displayed. In this way, when a viewer again selects that channel, either through a program selection control list (or control list based menu) or otherwise, those settings may be recalled and used, either as a default setting or as an optional one.

Although the present invention has been described in detail, those skilled in the art should understand that they can make various changes, substitutions and alterations herein without departing from the spirit and scope of the invention in its broadest form.

What is claimed is:

1. In a television system capable of selectively displaying program input from a plurality of programming channels, a system for enhanced programming channel-selection control, said system comprising:
a selector for selecting the programming input to process for display;
a timer for timing the amount of time each channel is selected for display;
a database for recording channel-selection durations;
a processor in communication with the database for periodically compiling a program selection control list, wherein the program selection control list includes channels selected and assigned weight values relative to other listed channels, said weighted values calculated according to a pre-determined algorithm from the channel-selection durations stored on the database.

2. The system of claim 1, wherein a higher weight value is assigned to channels having greater timed viewing durations and wherein the channels listed on the program selection control list are listed beginning with the channel having the highest relative weight value.

3. The system of claim 1, further comprising a viewer preference profile.

4. The system of claim 3, wherein the viewer preference profile comprises automatically generated viewer-preference information.

5. The system of claim 3, wherein the processor generates an adjusted program selection control list by applying information stored on the viewer preference profile to the program selection control list.

6. The system of claim 1, wherein the system is capable of generating and storing a plurality of program selection control lists.

7. The system of claim 6, wherein the processor determines which of the program selection control lists to apply to the channel selection process.

8. The system of claim 7, further comprising a clock for determining the day and time, and wherein the processor uses clock data as a factor in determining which program selection control list to use.

9. The system of claim 7, wherein the processor uses viewer identity as a factor in determining which program selection control list to use.

10. The system of claim 1, wherein the selector uses the program selection control list to determine which programming input to select for display.

11. The system of claim 10, wherein the selector successively uses a plurality of program selection control lists to determine which programming input to select for display.

12. A method for enhancing channel selection in a television system capable of displaying a program selected from a plurality of available program channels, said method comprising:
maintaining a viewing-history record of the amount of time each displayed program channel is displayed by the television system;
ranking each displayed channel relative to the other displayed channels according to the display time in the viewing-history record; and
creating a program selection control list based on the displayed channel ranking.

13. The method of claim 12, wherein the viewing-history record also includes information relating to the time of day during which the displayed program was displayed.

14. The method of claim 12, wherein the viewing-history record also includes information relating to the day of the week during which the displayed program was displayed.

15. The method of claim 12, wherein the step of creating a program selection control list comprises creating a plurality of program selection control lists.

16. The method of claim 15, further comprising the step of determining, upon receiving a control list invoke signal, the appropriate program selection control list to use.

17. The method of claim 12, further comprising the step of updating the program selection control list.

18. The method of claim 17, further comprising the step of creating a preference profile based on viewer input, the profile containing an update mode selection, and wherein the program selection control list is updated according to the selected update mode.
